(19) United States
(12) Patent Application Publication
(10) Pub. No.: US 2015/0194679 A1
(43) Pub. Date: Jul. 9, 2015

(54) METHOD FOR PRODUCING BATTERY AND BATTERY

(71) Applicant: Hiroaki Ikeda, Toyota-shi (JP)

(72) Inventor: Hiroaki Ikeda, Toyota-shi (JP)

(73) Assignee: TOYOTA JIDOSHA KABUSHIKI KAISHA, Toyota-shi (JP)

(21) Appl. No.: 14/419,544

(22) PCT Filed: May 8, 2013
(86) PCT No.: PCT/JP2013/062892

§ 371 Date: Feb. 4, 2015

(30) Foreign Application Priority Data
Aug. 9, 2012 (JP) 2012-177537

(51) Int. Cl. H01M 4/62; H01M 10/0587; H01M 2/26; H01M 10/0525; H01M 4/66; H01M 2/30

(52) U.S. Cl. CPC H01M 4/628; H01M 4/661; H01M 2/30; H01M 2/26; H01M 10/0525; H01M 4/667; H01M 10/0587; H01M 2220/20

(57) ABSTRACT

This method for producing a battery is provided with: a step for forming an active material layer on a layer-formed portion of a copper foil that, at the entirety of the primary face thereof, does not have an oxide film at which the copper is oxidized or has an oxide film of which the thickness by which the copper has oxidized is no greater than 5.0 nm; then a step for forming an exposed oxide film (42d) at the exposed portion by oxidizing the exposed portion of the copper foil; then a step for injecting an electrolyte into the battery; and then a step for the initial charging of the battery.

### TECHNICAL FIELD

The present invention relates to a method for producing a battery and the battery including an electrode sheet having active material layers formed on parts of primary faces of a copper foil and an electrolyte.

### BACKGROUND ART

Heretofore, there is known a battery including an electrode sheet and an electrolyte. As an electrode sheet, it is known the one configured with a copper foil and active material layers formed on parts of primary faces of this copper foil. Patent Document 1 discloses a method for forming coatings made of copper oxide in entire primary faces of a copper foil. To be specific, it is disclosed in the document that the copper foil for a current collector of a lithium ion secondary battery has primary faces each being entirely formed with a surface coating with a thickness of 0.5 to 5 nm, the coating being configured with a copper oxide film and/or an anti-rust film.

### RELATED ART DOCUMENTS

### Patent Documents

Patent Document 1: JP2012-099351A

### SUMMARY OF INVENTION

### Problems to be Solved by the Invention

Inventors of the present invention found that in a battery including an electrode sheet formed with active material layers on a copper foil, copper could be dissolved in an electrolyte from the copper foil during the time period between the electrolyte being injected into the battery and the battery being initially charged. The reason for this is assumed that an electric potential of a negative electrode is higher than a dissolution potential of the copper in a battery before initial charging. Especially, in an exposed portion exposed on primary faces of the copper foil with no active material layers, the copper is easily dissolved since the portion is not covered with the active material layers. When the battery in which the copper has been dissolved into the electrolyte is initially charged, the dissolved copper (copper ion) is reduced and precipitated on each surface of the active material layers. Then, this precipitated copper keeps (impedes) ion such as lithium ion, that taking a role of electric conduction, from coming in and out of the active material layers, so that resistance of the electrode sheet could be increased. As a result, it is confirmed that battery performance especially battery output at low temperature, is declined.

To solve this problem, the inventors of the present invention discovered that forming an oxide film made of oxidized copper with a thickness of 6.0 nm or more in each primary face of the copper foil is enabled to appropriately control dissolution of the copper from the copper foil to the electrolyte in this oxide film. Generally in many cases, an oxide film with a thickness of about 2 to 5 nm has already been formed in each of the entire primary faces of the copper foil. It is presumed that this oxide film has been formed by oxidization of the copper in the primary faces in occasions such as dealing the copper foil or producing the electrode sheet. However, there is a case that dissolution of the copper cannot be appropriately restrained if the oxide film is made thin. On the contrary, if a thick oxide film is respectively formed in the entire primary faces of the copper foil, even though dissolution of the copper before initial charging can be restrained, the resistance between the copper foil and each of the active material layers could be high due to the existence of the oxide film in an interface with the active material layer, and therefore the battery performance (especially battery output at low temperature) becomes declined.

The present invention has been made in view of the above circumstances and has a purpose to provide a method for producing a battery and a battery capable of appropriately restraining copper from being dissolved in an electrolyte from a copper foil before initial charging and thereby enhancing battery performance.

### Means of Solving the Problems

To solve the above problem, one aspect of the present invention is to provide a method for producing a battery including: an electrode sheet having a copper foil and an active material layer formed partially on each of front and back primary faces of the copper foil; and an electrolyte, the copper foil being configured such that: each of the primary faces includes a layer-formed portion on which the active material layer exists, the layer-formed portion being formed with either no oxide film made of oxidized copper or an oxide film located under the active material and made of oxidized copper with a thickness of 5.0 nm or less; and each of the primary faces includes an exposed portion where the primary face is exposed, the exposed portion having an exposed oxide film made of oxidized copper with a thickness thicker than the layer-formed portion, wherein the method comprises: an active material layer forming step of forming the active material layer on the layer-formed portion of each of the entire primary faces of the copper foil having no oxide film made of oxidized copper or having the oxide film made of oxidized copper with the thickness of 5.0 nm or less; a coating forming step of forming the exposed oxide film in the exposed portion by oxidizing the exposed portion of the copper foil after the active material layer forming step; an injection step of injecting the electrolyte into the battery after the coating forming step; and an initial charging step of initially charging the battery after the injection step.

In this method for producing the battery, active material layers are formed on the copper foil with no oxide film made of oxidized copper in entire primary faces or on the copper foil having only a thin oxide film with a thickness of 5.0 nm or less (the active material layer forming step), and subsequently, the exposed portion of the copper foil is oxidized to form the thick exposed oxide film on this exposed portion (the coating forming step). By forming the thick exposed oxide film on the exposed portion in this manner, it is possible to appropriately restrain the copper from being dissolved into the electrolyte from the exposed portion during the time period between injection of the electrolyte into the battery in the injection step and initial charging of the battery in the initial charging step. Accordingly, in the initial charging step, it is possible to prevent or restrain increase in the resistance of the electrode sheet due to precipitation of the dissolved copper on the surfaces of the active material layers, and thereby it can be prevented or restrained that the battery performance (especially the battery output at low temperature) is declined. On the other hand, the layer-formed portion of the copper foil has no oxide film or only has a thin oxide film under active material with a thickness of 5.0 nm or less. Therefore, it is possible to produce the battery capable of preventing or restraining the decline in the battery performance (especially the battery output at low temperature) due to the high resistance between the copper foil and each of the active material layers.

“The electrode sheet” may be either one of a positive electrode sheet in which a positive electrode foil made of copper foil is formed with positive active material layers including positive active material and others or a negative electrode sheet in which a negative electrode foil made of copper foil is formed with negative active material layers including negative active material and others. Alternately, the electrode sheet may be a bipolar electrode sheet in which one primary face of the copper foil is formed with a positive active material layer and the other primary face is formed with a negative active material layer. To be concrete, “the copper foil” may be either one of an electrode foil for a positive electrode or an electrode foil for a negative electrode. Alternately, the copper foil may be an electrode foil for a bipolar electrode. Further, “the electrode sheet” may be, for example, either one of configuration configuring a wound electrode body formed by placing a strip-shaped positive electrode sheet and a strip-shaped negative electrode sheet one on another and winding them with interposing a separator between them or configuration of a laminated electrode body formed by laminating a plurality of positive and negative electrode sheets of predetermined shape (for example, of rectangular shape) with interposing separators between them.

“The coating forming step” may be performed after “the active material layer forming step” and before “the injection step,” and for example, the step may be applied to the electrode sheet formed with the active material layers on the copper foil. Alternately, the step may be carried out after the wound or laminated electrode body is formed by use of the electrode sheet. Alternately, the step may be carried out after the terminal member is connected to the electrode body. Further, the step may be carried out before injection of the electrolyte in a state that the electrode body is accommodated in the battery case and the battery is assembled.

In the above method, preferably, the coating forming step includes forming the exposed oxide film having a thickness of 6.0 nm or more.

In this method, dissolution of copper before the initial charging step can be effectively restrained since the thickness of the exposed oxide film formed on the exposed portion of the copper foil is made to be 6.0 nm or more in the coating forming step.

In the above method, further preferably, the coating forming step includes forming the exposed oxide film having a thickness of 17.0 nm or less.

Even if the thickness of the exposed oxide film formed on the exposed portion of the copper foil is made greater than 17.0 nm in the coating forming step, the effect of restraining the dissolution of the copper before initial charging is not so improved. Moreover, for making the exposed oxide film thick, cost and man-hour is much required. On the other hand, in the above method for producing the battery, the thickness of the exposed oxide film formed in the coating forming step is made to be 17.0 nm or less, and the dissolution of the copper before the initial charging step can be appropriately restrained. Furthermore, cost and man-hour can be reduced in forming the exposed oxide film in the coating forming step, thus reducing the expenses for producing the battery.

In the above method, further preferably, the coating forming step includes heating at least the exposed portion of the copper foil at a temperature range of 80° C. to 100° C. for 10 to 180 minutes under atmospheric circumstances.

In the coating forming step, if the heating temperature is set to be lower than 80° C., or the heating period is set to be shorter than 10 minutes, there is a possibility that the exposed oxide film is not made thick on the exposed portion of the copper foil. On the other hand, if the heating temperature is set to be higher than 110° C., or the heating period is set to be longer than 180 minutes, there is a possibility that the oxide film under active material is formed on the layer-formed portion of the copper foil, so that the oxide film under active material could be thick. This could cause increase in resistance between the copper foil and each of the active material layers.

In contrast, in the coating forming step according to the above method for producing the battery, at least the exposed portion of the copper foil is heated in the temperature range of 80° C. to 110° C. for 10 to 180 minutes under atmospheric circumstances. Thereby, the thick exposed oxide film can be easily and surely formed in the exposed portion of the copper foil, and further, it is surely prevented that the resistance between the copper foil and each of the active material layers is increased due to the formation of the oxide film under active material on the layer-formed portions of the copper foil or the formation of the thick oxide film under active material.

In the above method, further preferably, the battery includes a terminal member welded to the exposed portion of the copper foil of the electrode sheet, and the method includes a terminal welding step of welding the terminal member to the exposed portion of the copper foil prior to the coating forming step.

If the coating forming step is carried out prior to the terminal welding step, the thick oxide film is formed on a part of the exposed portion of the copper foil where the terminal member is to be welded. This causes decline in welding performance of welding the terminal member to the copper foil due to the existence of this oxide film. Namely, the terminal member might not be surely welded to the copper foil. In contrast, according to the above method for producing the battery, the terminal welding step is performed prior to the coating forming step. Therefore, the terminal member can be surely welded to the copper foil. Further, conductivity of the welded part of the terminal member and the copper foil is not changed even after the coating forming step is performed, and thus stable connection state is maintained.

Another aspect of the present invention is to provide a battery including: an electrode sheet having a copper foil and an active material layer formed on a part of each of front and back primary faces of the copper foil; and an electrolyte, wherein the copper foil is configured such that: each of the primary faces includes a layer-formed portion on which the active material layer exists, the layer-formed portion being formed with either no oxide film made of oxidized copper or having an oxide film located under the active material and made of oxidized copper with a thickness of 5.0 nm or less; and each of the primary faces includes an exposed portion, where the face is exposed, the exposed portion having an exposed oxide film made of oxidized copper with a thickness thicker than the layer-formed portion.

According to this battery, in the primary faces of the copper foil, the thick exposed oxide film exists on the exposed portion where no active material layers exist and the primary faces are exposed. Thereby, during the time period between the injection of the electrolyte into the battery and the initial charging of the battery, the copper is appropriately prevented from being dissolved into the electrolyte from the exposed portion of the copper foil. Consequently, when initially charging the battery, it can be prevented or restrained that the dissolved copper is precipitated on surfaces of the active material layers and that the resistance of the electrode sheet is increased, and therefore decline in the battery performance (especially the battery output at low temperature) is prevented or restrained. Further, in the primary faces of the copper foil, the layer-formed portions, where the active material layers exist, have no oxide film or only has the oxide film under active material with a thin thickness of 5.0 nm or less. Therefore, it can be prevented or restrained that the resistance between the copper foil and the active material layer becomes high due to the oxide film and that the battery performance (especially the battery output at low temperature) is declined.

In the above battery, preferably, the exposed oxide film has a thickness of 6.0 nm or more.

According to this battery, dissolution of the copper before initial charging can be effectively restrained since the thickness of the exposed oxide film of the exposed portion is made to be 6.0 nm or more.

In the above battery, further preferably, the exposed oxide film has a thickness of 17.0 nm or less.

According to this battery, since the thickness of the exposed oxide film of the exposed portion is made to be 17.0 nm or less, dissolution of the copper before initial charging can be restrained and the cost and man-hour for forming the exposed oxide film on the exposed portion can be reduced. As a result, the battery may be produced with less expenses.

In the above battery, further preferably, the battery includes a terminal member welded to the exposed portion of the copper foil of the electrode sheet, and the exposed oxide film is formed after the terminal member has been welded to the copper foil.

According to this battery, the terminal member is welded to the exposed portion of the copper foil before the exposed oxide film is formed on the exposed portion of the copper foil, and thereby the terminal member is surely welded to the copper foil. Further, the exposed oxide film to be formed thereafter can be formed on an appropriate position and the conductivity of the welded part of the terminal member and the copper foil is not changed, so that the connection state between the terminal member and the copper foil is stabilized.

### BRIEF DESCRIPTION OF THE DRAWINGS

FIG. 1 is a perspective view of a lithium ion secondary battery of an embodiment;

FIG. 2 is a vertical cross sectional view of the lithium ion secondary battery of the embodiment;

FIG. 3 is an exploded perspective view of a case lid member, a positive terminal, a negative terminal, and others of a battery case of the embodiment;

FIG. 4 is a perspective view of an electrode body of the embodiment;

FIG. 5 is a development view of the electrode body, showing a state that a positive electrode sheet and a negative electrode sheet are placed one on another with interposing a separator between them according to the embodiment;

FIG. 6 is a sectional view of the negative electrode sheet of the embodiment;

FIG. 7 is a graph showing a relation of a heating period and battery output at low temperature in a coating forming step; and

FIG. 8 is a graph showing a relation of the heating period and a thickness of an exposed oxide film on an exposed portion of a negative electrode foil in the coating forming step.

### MODE FOR CARRYING OUT THE INVENTION

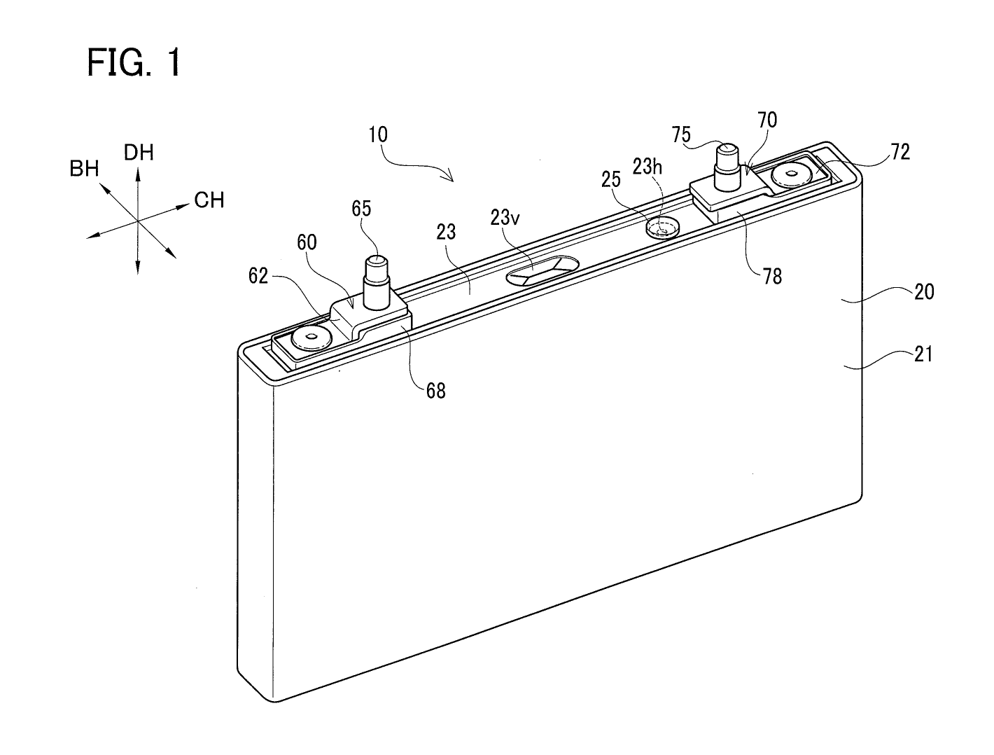

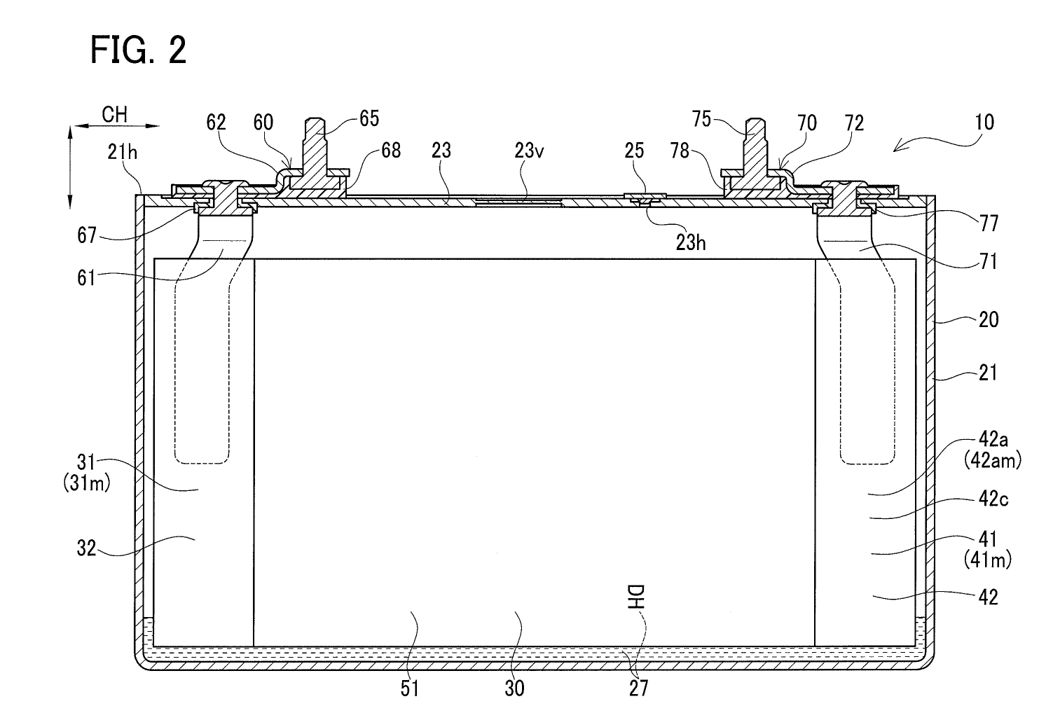

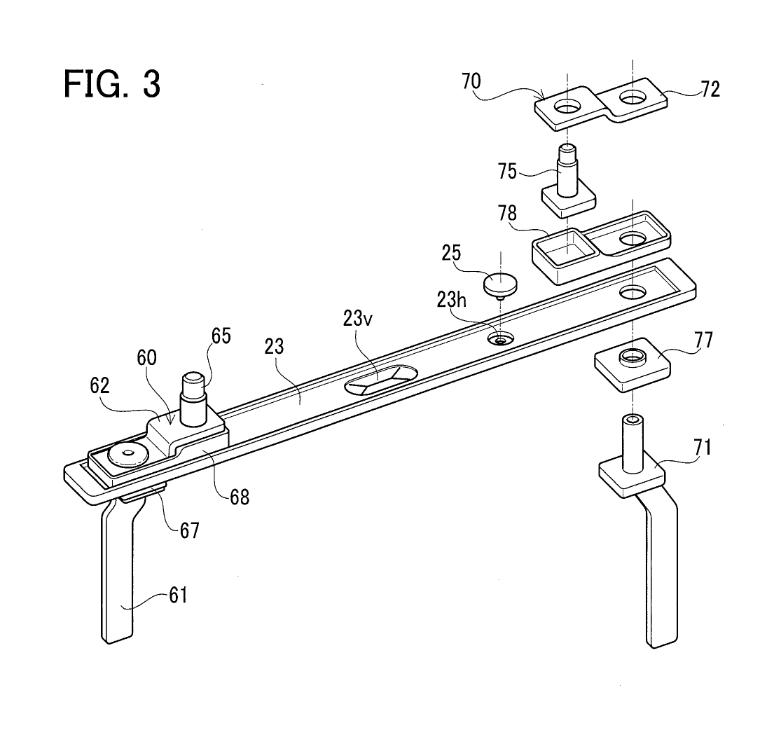

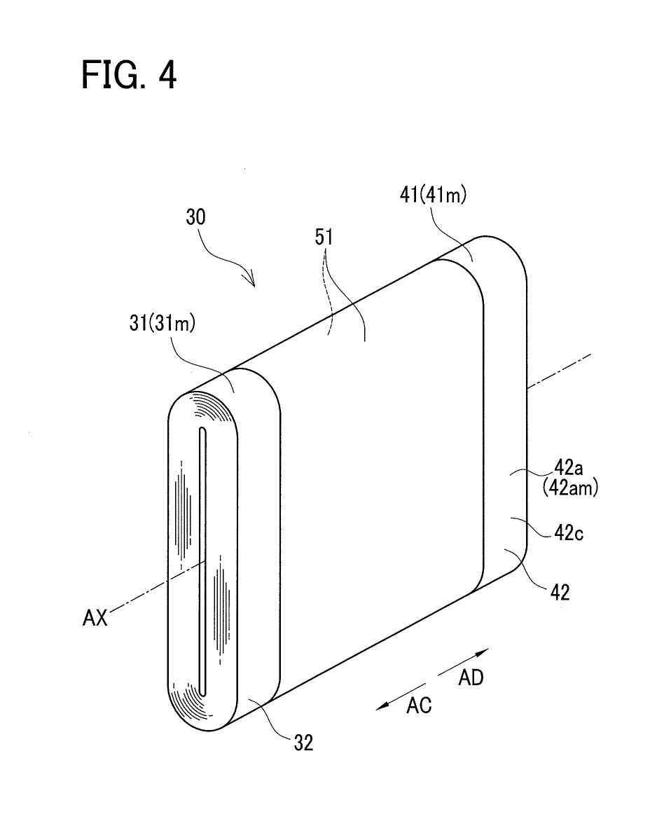

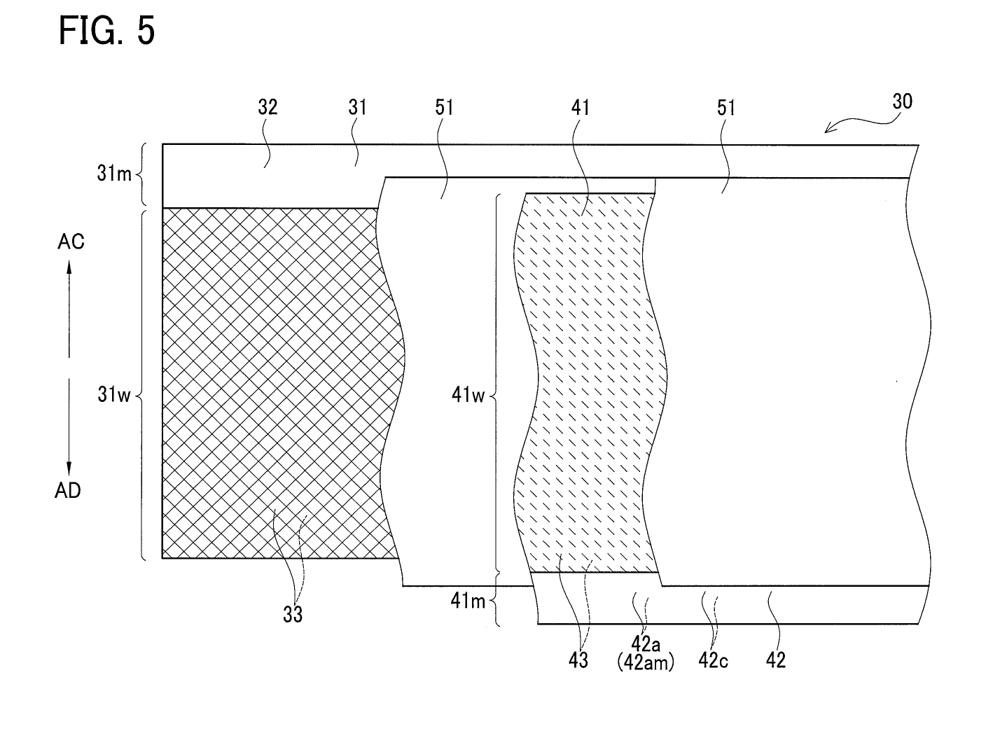

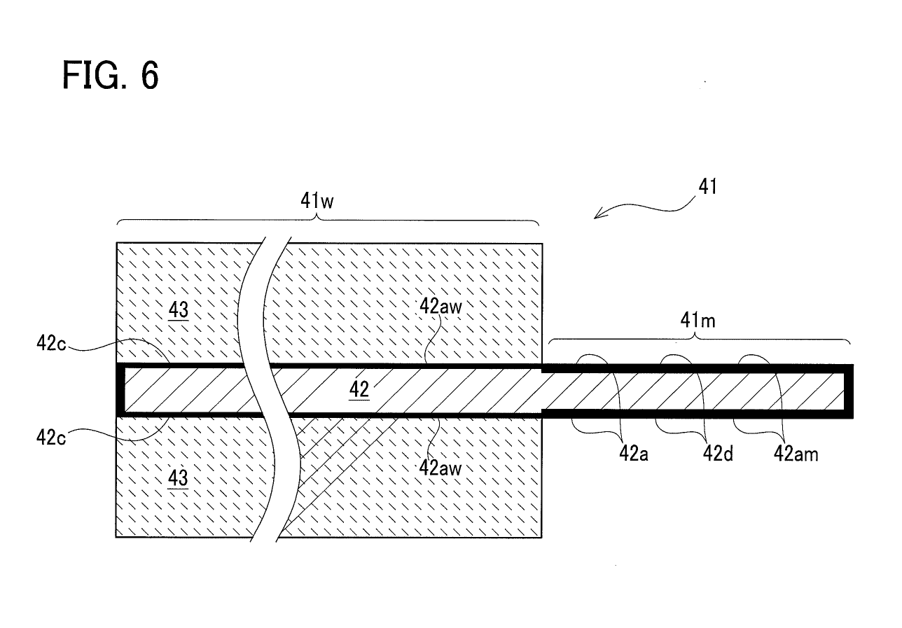

A detailed description of a preferred embodiment of the present invention will be now given referring to the accompanying drawings. FIGS. 1 and 2 show a lithium ion secondary battery 10 (hereinafter, also simply referred to as a battery 10). FIG. 3 shows a case lid member 23, a positive terminal 60, a negative terminal 70, and others of a battery case 20. FIGS. 4 and 5 show an electrode body 30. FIG. 6 shows a negative electrode sheet 41. The following explanation is made indicating that a direction of a thickness of the battery 10 is indicated by BH, a direction of a width of the same is indicated by CH, and a direction of a height of the same is indicated by DH in FIGS. 1 and 2. Further, the following explanation is made assuming that an upper part in FIGS. 1 and 2 corresponds to an upper side of the battery 10 and a lower part corresponds to a lower side of the battery 10.

This battery 10 is a rectangular hermetically-closed battery to be mounted in a vehicle such as a hybrid car and an electric car. This battery 10 includes a rectangular parallelepiped battery case 20, a flat-wound electrode body 30 accommodated in this battery case 20, a positive terminal 60 and a negative terminal 70 each supported in the battery case 20, and others. In the battery case 20, non-aqueous electrolyte 27 is retained.

The battery case 20 is made of metal (concretely, aluminum). This battery case 20 is configured with a bottom-closed prismatic cylindrical body member 21 having a rectangular opening 21h on only an upper side and a rectangular plate-like case lid member 23 for closing this opening 21h of the body member 21 (see FIGS. 1 to 3). The case lid member 23 is provided, near its center in a longitudinal direction (corresponding to the width direction CH of the battery 10), with a non-return safety valve 23v. Further, near the safety valve 23v, there is provided a liquid inlet 23h to be used for injection of the electrolyte 27 into the battery case 20, and the liquid inlet 23h is hermetically sealed with a sealing member 25.

Near both ends of the case lid member 23 in the longitudinal direction, a positive electrode terminal (positive terminal member) 60 and a negative electrode terminal (negative terminal member) 70 extending from inside of the battery case 20 to outside are respectively fixed to the case lid member 23. To be specific, the positive terminal 60 and the negative terminal 70 are respectively connected to the electrode body 30 in the battery case 20 and configured with: first terminal members 61 and 71 penetrating the case lid member 23 to extend outside from the battery case 20; and crank-shaped second terminal members 62 and 72 placed on the case lid member 23 to be swaged to the first terminal members 61 and 71. The positive terminal 60 and the negative terminal 70 are fixed to the case lid member 23 with metal-made fastening members 65 and 75 for fastening connection terminals such as a bus bar and a pressure connection terminal outside the battery by means of resin-made first insulating members 67 and 77 disposed inside the case lid member 23 (inside the case) and resin-made second insulating members 68 and 78 disposed outside the case lid member 23 (outside the case).

The electrode body 30 will be explained below (see FIGS. 2, 4, and 5). This electrode body 30 is accommodated in the battery case 20 so that the electrode body 30 is placed sideways with its axis (winding axis) AX being parallel to the width direction CH of the battery 10 (see FIG. 2). This electrode body 30 is an assembly of a strip-shaped positive electrode sheet 31 and a strip-shaped negative electrode sheet 41 that are placed one on another by interposing two strip-shaped separators 51 each made of a resin-made porous film between the electrode sheets 31 and 41 (see FIG. 5), and compressed in a flat shape (see FIG. 4).

A part of a positive current collecting portion 31m of the positive electrode sheet 31, which will be explained later, protrudes in a spiral shape on one side AC (leftward in FIGS. 2 and 4, and upward in FIG. 5) in the direction of axis AX from the separators 51 and is connected (welded) to the above mentioned positive terminal 60. A part of a negative current collecting portion 41m of the negative electrode sheet 41, which will be explained later, protrudes in a spiral shape on the other side AD (rightward in FIGS. 2 and 4, and downward in FIG. 5) in the direction of axis AX from the separators 51 and is connected (welded) to the above mentioned negative terminal 70.

The positive electrode sheet 31 includes a strip-shaped positive electrode foil 32 made of aluminum as a core. On a part (downward in FIG. 5) in the width direction (vertical direction in FIG. 5) of front and back primary faces of this positive electrode foil 32, positive active material layers 33 are respectively formed extending in the longitudinal direction (lateral direction in FIG. 5) in a strip-like shape. A strip-shaped part of the positive electrode sheet 31 where the positive electrode foil 32 and the positive active material layers 33 exist in the thickness direction is defined as a positive electrode part 31w. On the other hand, another strip-shaped part of the positive electrode sheet 31, where no positive active material layers 33 exist but only the positive electrode foil 32 exists in its thickness direction, is defined as a positive current collecting part 31m. The positive active material layers 33 are made of positive active material, conductive agent, and binder. In the present embodiment, complex oxide with lithium, cobalt, nickel and manganese, more specifically, LiCo_{1/3}Ni_{1/3}Mn_{1/3}O₂ is used as the positive active material. As the conductive agent, acetylene black (AB) is used, and polyvinylidene fluoride (PVDF) is used as the binder.

The negative electrode sheet 41 (see FIGS. 2, 4, 5, and 6) includes a strip-shaped negative electrode foil (copper foil) 42 made of copper as a core. On a part (upward in FIG. 5) of front and back primary faces 42a of the negative electrode foil 42 in the width direction (vertical direction in FIG. 5), negative active material layers (active material layers) 43 are respectively formed extending in a strip-like shape in the longitudinal direction (lateral direction in FIG. 5). Strip-shaped parts of the primary faces 42a of the negative electrode foil 42 on which the negative active material layers 43 exist are defined as layer-formed portions 42aw. Strip-shaped parts of the primary faces 42a, on which no negative active material layers 43 exist and the primary faces are exposed, are defined as exposed portions 42am.

This negative electrode foil 42 includes thin oxide films under active material 42c made of oxidized copper with a thickness Ea of 5.0 nm or less (in the present embodiment, Ea=3.0 nm) on each of the layer-formed portions 42aw of the primary faces 42a. The oxide films under active material 42c are, which will be explained later, formed before the electrode body 30 is fabricated (before the negative electrode sheet 41 is formed). Further, the negative electrode foil 42 includes thick exposed oxide films 42d each made of oxidized copper with a thickness Ea in a range of 6.0 nm to 17.0 nm (in the present embodiment, Ea=10.0 nm) on the exposed portions 42am of the primary faces 42a. The exposed oxide films 42d are, which will be explained later, formed after the negative electrode terminal (negative terminal member) 70 and the negative electrode foil 42 are welded but before the electrolyte 27 is injected.

A strip-shaped part of the negative electrode sheet 41, where the negative electrode foil 42 and the negative active material layers 43 exist in its thickness direction, is defined as a negative electrode part 41w. Further, another strip-shaped part of the negative electrode sheet 41, where no negative active material layers 43 exist but only the negative electrode foil 42 exists in its thickness direction, is defined as a negative current collecting part 41m. The negative active material layer 43 is configured with negative active material, thickener, and binder. In the present embodiment, graphite, more specifically, natural graphite is used as the negative active material. As the thickener, carboxymethyl cellulose (CMC) is used, and styrene-butadiene rubber (SBR) is used as the binder.

As explained above, in the battery 10, the exposed portions 42am of the primary faces 42a of the negative electrode foil 42 include thick exposed oxide films 42d. Thereby, 5 as will be explained later, it is appropriately restrained that copper is dissolved into the electrolyte 27 from the exposed portions 42am of the negative electrode coating 42 during the time period between the injection of the electrolyte 27 into the battery and the initial charging of the battery. Accordingly, during initial charging of the battery, it can be restrained that the dissolved copper is precipitated on each surface of the negative active material layers 43 to increase the resistance of the negative electrode sheet 41, and thereby decline in battery performance (especially battery output at low temperature) can be restrained. On the other hand, the layer-formed portions 42aw of the primary faces 42a of the negative electrode foil 42 only includes the thin oxide films under active material 42c each having a thickness Ea of 5.0 nm or less. Accordingly, it can be restrained that the resistance between the negative electrode foil 42 and the negative active material layer 43 is increased to cause decline in the battery performance (especially battery output at low temperature) due to interposition of these oxidized coatings under active material 42c.

Further in the present embodiment, the thickness Ea of each of the exposed oxide films 42d of the exposed portions 42am is arranged to be 6.0 nm or more, and thereby dissolution of copper before initial charging can be effectively restrained. The thickness Ea of this exposed oxide films 42d is further arranged to be 17.0 nm or less, and thereby not only properly restraining the dissolution of the copper before initial charging but also reducing cost and man-hour for forming the exposed oxide films 42d in the exposed portions 42am. Accordingly, the battery 10 can be produced with less expenses.

In the present embodiment, the negative electrode terminal member 70 is welded to the negative electrode foil 42 before the exposed oxide films 42d are formed on the exposed portions 42am, thus achieving secure welding of the negative terminal member 70 to the negative electrode foil 42. Also, the exposed oxide films 42d to be formed later can be formed in appropriate positions and the conductivity at the welded part of the negative terminal member 70 and the negative electrode foil 42 is not changed, so that the connection state between the negative terminal member 70 and the negative electrode foil 42 is stabilized.

Next, a method for producing the above battery 10 will be explained. First, the negative electrode sheet 41 is produced (a negative electrode sheet producing step). Specifically, a strip-shaped negative electrode foil (copper foil) 42 is prepared. This negative electrode foil 42 has already been entirely formed with thin oxide films each having a thickness Ea of 5.0 nm or less (in the present embodiment, Ea=2.0 nm) in both primary faces 42a. It is presumed that these thin oxide films were formed when handling the negative electrode foil 42.

Then, in an active material layer forming step of the negative electrode sheet producing step, on a part (the layer-formed portion 42aw) of one primary face 42a of the negative electrode foil 42 in the width direction, negative electrode paste including negative active material, thickener, and binder is coated and then dried with hot air to form the negative active material layer 43 (see FIG. 6). Similarly, on a part (the layer-formed portion 42aw) of the other primary face 42a on the other side of the negative electrode foil 42 in the width direction, the above negative electrode paste is coated and then dried with hot air to form the negative active material layer 43. By the heat applied to form these negative active material layers 43 (concretely, heated at 180° C. for 20 seconds in total), each thickness Ea of the oxide films in both primary faces 42a of the negative electrode foil 42 is increased from 2.0 nm by 1.0 nm to 3.0 nm. After that, the negative active material layers 43 are compressed by a pressure roller to enhance the density. Thus, the negative electrode sheet 41 is produced.

Separately, the positive electrode sheet 31 is produced (a positive electrode sheet producing step). Specifically, a strip-shaped positive electrode foil (aluminum foil) 32 is prepared. Then, on a part of one primary face of this positive electrode foil 32 in the width direction, positive electrode paste including positive active material, conductive agent, and binder is coated and then dried with hot air to form the positive active material layer 33 (see FIG. 5). Similarly, on a part of the other primary face on the other side of the positive electrode foil 32 in the width direction, the above positive electrode paste is coated and then dried with hot air to form the positive active material layer 33. After that, the positive active material layers 33 are compressed by the pressure roller to enhance the density. Thus, the positive electrode sheet 31 is produced.

Next in an electrode body forming step, two strip-shaped separators 51 are prepared. The above positive electrode sheet 31 and the above negative electrode sheet 41 are placed one on another with interposing these separators 51 between them (see FIG. 5) and then wound around the axis AX by use of a winding core. After that, this assembly is compressed to be flat-shaped to form the electrode body 30 (see FIG. 4). Further, each of the case lid member 23, the first terminal members 61 and 71, the second terminal members 62 and 72, the fastening members 65 and 75, the first insulating members 67 and 77, and the second insulating members 68 and 78 is prepared. In a terminal forming step, the positive electrode terminal 60 and the negative electrode terminal 70 are respectively fixed to the case lid member 23 by use of these elements (see FIG. 3).

Next in a terminal welding step, the positive terminal 60 fixed to the case lid member 23 is welded to the positive current collecting part 31m (an exposed portion of the positive electrode foil 32) of the positive electrode sheet 31 in the electrode body 30. Further, the negative terminal 70 fixed to the case lid member 23 is welded to the negative current collecting part 41m (the exposed portion 42am of the negative electrode foil 42) of the negative electrode sheet 41. Subsequently, the body member 21 is prepared in a battery assembling step to accommodate the electrode body 30 in the body member 21, and the opening 21h of the body member 21 is closed with the case lid member 23. The opening 21h of the body member 21 and the case lid member 23 are circumferentially laser-welded and hermetically bonded so that a battery before injection of the electrolyte 27 is produced.

Next in a coating forming step, the exposed portions 42am of the negative electrode foil 42 are oxidized to form the exposed oxide films 42d each having a thickness Ea in the range of 6.0 nm to 17.0 nm (in the present embodiment, Ea=10.0 nm) on this exposed portions 42am. To be specific, this battery before injection is entered into a heating furnace and the battery as a whole is heated at the temperature range of 80° C. to 110° C. (in the present embodiment, 100° C.) for 10 to 180 minutes (in the present embodiment, 60 minutes) under atmospheric circumstances. In this manner, copper of the exposed portions 42am of the negative electrode foil 42 is oxidized to increase the thickness Ea of the already existing oxide film by 7.0 nm (in the present embodiment, Ea=3.0 nm), so that the exposed oxide films 42d with the thickness Ea of 10.0 nm are formed on the exposed portions 42am.

Incidentally, in this coating forming step, the copper of the layer-formed portions 42aw is hard to be oxidized since each of the layer-formed portions 42aw of the negative electrode foil 42 is covered with the negative active material layers 43. Therefore, each thickness Ea (in the present embodiment, Ea=3.0 nm) of the oxide films under active material 42c of the layer-formed portions 42aw is hardly increased. Accordingly, in the negative electrode sheet 41 which has been applied with this coating forming step, the layer-formed portions 42aw of the primary faces 42a of the negative electrode foil 42 have the thin oxide films under active material 42c each having the thickness Ea of 3.0 nm while the exposed portions 42am have the thick exposed oxide films 42d each having the thickness Ea of 10.0 nm.

Next in an injection step, the electrolyte 27 is injected in the battery case 20 from the liquid inlet 23h and the liquid inlet 23h is hermetically closed with the sealing member 25. Thereafter, in the initial charging step, this battery is initially charged. The battery 10 is thus completed.

(Test Results)

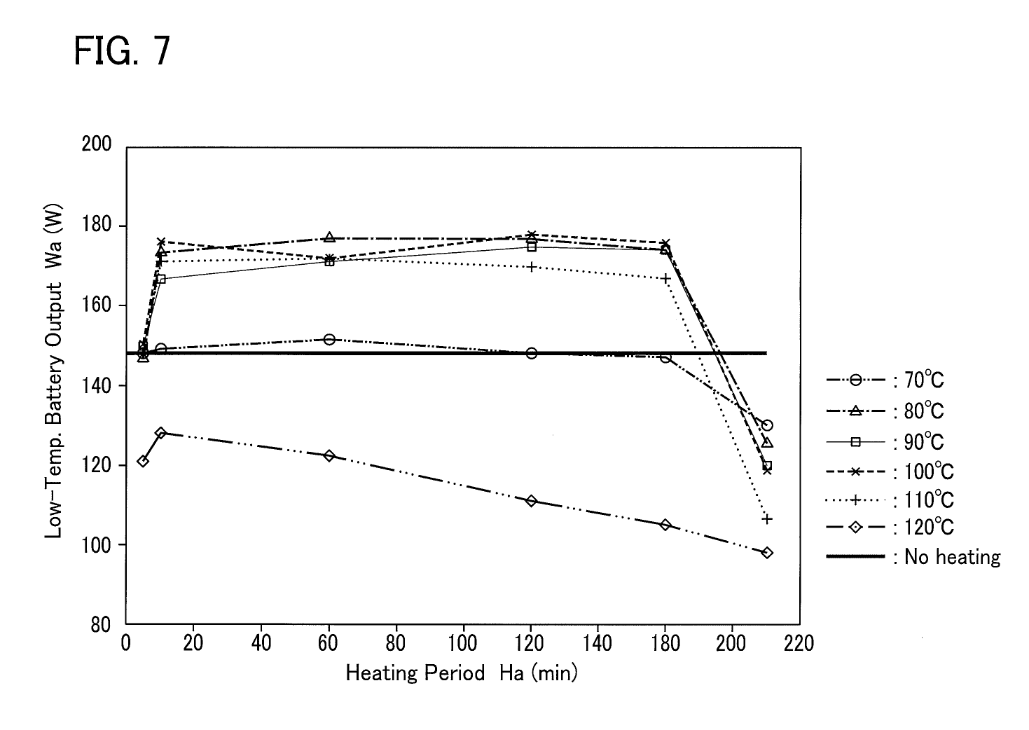

Next, it will be explained results of a test carried out for verifying the effect of the battery 10 and the method for producing the battery 10 according to the present embodiment. A plurality of batteries are produced with varying heating temperature Ta (° C.) and heating period Ha (min) for each battery in the above-mentioned coating forming step (FIG. 7). A battery which is not applied with the coating forming step but produced as similar to the above batteries is also prepared.

Then, “battery output at low temperature Wa (W)” of each battery (battery capacitance: 3.8 Ah) is obtained. Concretely, (1) the battery is adjusted to be in a charged state of SOC 27% (voltage across terminals of 3.55V), and (2) the battery is left as it is for 3 hours at −30° C. (in a state that inside the battery is remained at −30° C.). Thereafter, the battery is discharged with constant electric power of 110W until the voltage across terminals is reduced to 2.2V. Then, the above operations (1) and (2) are repeated again. Afterwards, the battery is discharged with the constant electric power of 130W until the voltage across terminals becomes 2.2V. Then, the above operations (1) and (2) are repeated again. Thereafter, the battery is discharged with the constant electric power of 150W until the voltage across terminals becomes 2.2V. Then, the above operations (1) and (2) are repeated again. The battery is discharged thereafter with the constant electric power of 170W until the voltage across terminals becomes 2.2V. The above operations (1) and (2) are repeated again. Finally, the battery is discharged with the constant electric power of 190W until the voltage across terminals becomes 2.2V.

Next, a log-log graph is given with lnHb (sec) of discharging period Hb (sec) required for acquiring the voltage across terminals of 2.2V as a horizontal axis and with lnWb (W) of the measured battery output Wb (W) as a vertical axis, and the graph is plotted with each measured results to obtain approximate lines of them. Then, the battery output Wb with the discharging period Hb=2(sec) is calculated and defined as “battery output at low temperature Wa.” FIG. 7 shows a relation between a heating period Ha and the battery output at low temperature Wa with a parameter of the heating temperature Ta.

As clear from FIG. 7, in a battery which is not applied with the coating forming step, the battery output at low temperature Wa is low as 148W. The reason for this result is explained as follows. Since this battery is not applied with the coating forming step, copper is dissolved into the electrolyte from the exposed portion of the negative electrode foil during the time period between the injection of the electrolyte in the battery and the initial charging of the battery. Then, when the battery is initially charged, the dissolved copper (copper ion) is reduced and precipitated on each surface of the negative active material layers. This precipitated copper impedes the lithium ion from coming in and out of the negative active material, resulting in increase in the resistance of the negative electrode sheet. Because of this, the battery output at low temperature Wa is considered to be lowered.

In each battery heated at the heating temperature Ta=70° C. in the coating forming step, the battery output at low temperature Wa is low as Wa=130 to 151W. The reason for this is explained as follows. Namely, in these batteries, the heating temperature Ta in the coating forming step is too low to form a thick exposed oxide film on the exposed portion of the negative electrode foil. Thereby, copper is dissolved into the electrolyte from the exposed portion of the negative electrode foil during the time period between the injection of the electrolyte in the battery and initial charging of the battery. As similar to the battery which is not applied with the coating forming step, it is concluded that the resistance of the negative electrode sheet is increased and thereby the battery output at low temperature Wa is lowered.

In each battery heated at the heating temperature Ta=120° C. in the coating forming step, the battery output at low temperature Wa is low as Wa=98 to 128W. The reason for this is explained below. Namely, in these batteries, the heating temperature Ta in the coating forming step is too high and therefore the oxide film on the layer-formed portion of the negative electrode foil is made thick, resulting in high resistance between the negative electrode foil and the negative active material layer. As a result, it is concluded that the battery output at low temperature Wa is lowered.

Further, in each battery at the heating temperature Ta=80° C., 90° C., 100° C., and 110° C. with the heating period Ha=5 minutes in the coating forming step, the battery output at low temperature Wa of each battery is low as Wa=147 to 150W. The reason for this is explained as follows. Namely, the heating period Ha for heating these batteries in the coating forming step is too short, and thereby the thick exposed oxide film is not formed in the exposed portion of the negative electrode foil. As a result, the copper could be dissolved into the electrolyte from the exposed portion of the negative electrode foil during the time period between the injection of the electrolyte in the battery and the initial charging of the battery. Thus, as similar to the battery which is not applied with the coating forming step, it is concluded that the resistance of the negative electrode sheet is increased and thereby the battery output at low temperature Wa is lowered.

Further, in each battery at the heating temperature Ta=80° C., 90° C., 100° C., and 110° C. with the heating period Ha=210 minutes in the coating forming step, the battery output at low temperature Wa of each battery is low as 107 to 126W. The reason for this is explained as follows. Namely, the heating period Ha in the coating forming step is too long, and thereby the oxide film in the layer-formed portion of the negative electrode foil becomes thick, resulting in high resistance between the negative electrode foil and the negative active material layer. As a result, it is concluded that the battery output at low temperature Wa is lowered.

On the other hand, in each battery heated respectively at the heating temperature Ta=80° C., 90° C., 100° C., and 110° C. with the heating period Ha=10 minutes, 60 minutes, 120 minutes, and 180 minutes in the coating forming step, the battery output at low temperature Wa is high in the range of Wa=167 to 178W. The reason for this is explained as follows. Namely, in these batteries, the heating temperature Ta and the heating period Ha are appropriately arranged, and therefore the thickness Ea of the oxide film in the layer-formed portion of the negative electrode foil is rarely changed while the thick exposed oxide film is formed in the exposed portion of the negative electrode foil. Accordingly, it can be prevented that the copper is dissolved in the electrolyte from the exposed portion of the negative electrode foil and the resistance between the negative electrode foil and the negative active material layer is increased in the time period between the injection of the electrolyte into the battery and the initial charging of the battery. Owing to this, it is concluded that the battery output at low temperature Wa becomes high. From these results, it is concluded that the preferable battery output at low temperature Wa can be obtained by arranging the heating temperature Ta as 80 to 110° C. and the heating period Ha as 10 to 180 minutes in the coating forming step.

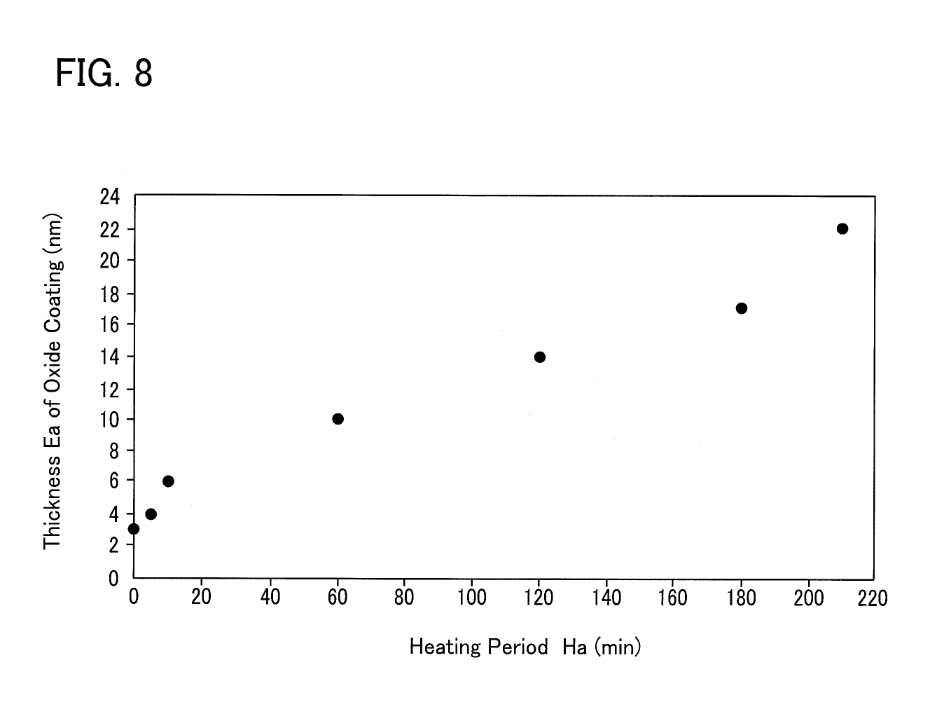

Next, batteries are prepared on condition that the heating temperature Ta is set as Ta=100° C. and the heating period Ha is respectively set as Ha=5 minutes, 10 minutes, 60 minutes, 120 minutes, 180 minutes, and 210 minutes in the coating forming step, and another battery produced without performing the coating forming step is also prepared. Each of these batteries is disassembled and taken out the negative electrode sheet in order to measure the thickness Ea of the exposed oxide film on the exposed portion of the negative electrode foil. To be specific, each thickness Ea of the exposed oxide film is measured by Auger Electron Spectroscopy (AES). Alternately, the thickness Ea of the exposed oxide film may be measured by Transmission Electron Microscope (TEM). The measured results are shown in FIG. 8.

As clearly shown in FIG. 8, in a battery with low battery output at low temperature Wa (heating period Ha=0 minute) due to inaction of the coating forming step, 15 the thickness Ea of the exposed oxide film is thin as Ea=3.0 nm. In another battery with low battery output at low temperature Wa due to too short heating period Ha (heating period Ha=5 minutes), the thickness Ea of the exposed oxide film is thin as Ea=4.0 nm. On the other hand, in the batteries with high battery output at low temperature Wa because of ample heating period Ha (heating period Ha=10 to 180 minutes), each thickness Ea of the exposed oxide films is thick as Ea=6.0 to 17.0 nm. Based on these results, it is preferable to arrange the thickness Ea of the exposed oxide film on the exposed portion of the negative electrode foil as Ea=6.0 nm or more.

Further, in a battery with low battery output at low temperature Wa due to long heating period Ha (heating period Ha=210 minutes), the thickness Ea of the exposed oxide film is thick as Ea=22.0 nm. As mentioned above, because the heating period Ha is too long, the oxide film on the layer-formed portion of the negative electrode foil of this battery could be thick, so that the resistance between the negative electrode foil and each of the negative active material layers is increased. As a result, it is considered that the battery output at low temperature becomes low.

As explained above, in the method for producing the battery 10, after the negative active material layers 43 are formed on the negative electrode foil 42 which only includes the thin oxide film with the thickness Ea of 5.0 nm or less on entire primary faces 42a (the active material layer forming step), the exposed portions 42am of the negative electrode foil 42 are oxidized to form the thick exposed oxide films 42d on these exposed portions 42am (the coating forming step). By forming the thick exposed oxide films 42d on the exposed portions 42am in this manner, it is properly restrained that copper is dissolved into the electrolyte 27 from the exposed portions 42am during the time period between the injection of the electrolyte 27 in the battery in the injection step and the initial charging of the battery in the initial charging step. Accordingly, in the initial charging step, it can be prevented that the resistance of the negative electrode sheet 41 is increased due to the precipitation of the dissolved copper on the surface of the negative active material layers 43 and that the battery performance (especially the battery output at low temperature) is declined. Further, the layer-formed portions 42aw of the negative electrode foil 42 only include thin oxide films under active material 42c each having the thickness Ea of 5.0 nm or less. Therefore, the battery 10 can be produced in a manner that the battery performance (especially the battery output at low temperature) is restrained from declining due to the increase in the resistance between the negative electrode foil 42 and the negative active material layer 43.

Further in the present embodiment, each thickness Ea of the exposed oxide films 42d formed on the exposed portions 42am of the negative electrode foil 42 is arranged to be 6.0 nm or more in the coating forming step, and therefore dissolution of the copper before the initial charging step can be further effectively prevented. Furthermore, the thickness Ea of these exposed oxide films 42d is arranged to be 17.0 nm or less, not only properly preventing dissolution of the copper before the initial charging step but also reducing costs and man-hour for forming the exposed oxide films 42d on the exposed portions 42am in the coating forming step. Accordingly, the battery 10 can be produced with less expenses.

Further in the coating forming step according to the present embodiment, the battery (battery before injection) is heated for 10 to 180 minutes at the temperature range of 80° C. to 110° C. under atmospheric circumstances. Thus, while thick exposed oxide films 42d can be easily and surely formed on the exposed portions 42am of the negative electrode foil 42, it is more certainly prevented that the resistance between the negative electrode foil 42 and the negative active material layers 43 is increased due to the thick oxide films under active material 42c on the layer-formed portions 42aw of the negative electrode foil 42. Furthermore, in the present embodiment, the terminal welding step is performed prior to the coating forming step. Thereby, the negative electrode terminal 70 can be surely welded to the negative electrode foil 42. Even when the coating forming step is carried out thereafter, the conductivity of the welded part of the negative terminal 70 and the negative electrode foil 42 is not changed, thus maintaining the stable connection state.

As above, the present invention is exemplified with the embodiment, but it is not limited to the above embodiment and may be applied with various changes without departing from the scope of its subject matter. For example, the present embodiment is exemplified with the thin oxide film under active material 42c with a thickness of 5.0 nm or less formed on the layer-formed portion 42aw of each of the primary faces 42a of the negative electrode foil 42. Alternately, the layer-formed portion may have no copper oxide film.

Further in the present embodiment, the coating forming step is performed to the battery before injection after the battery is assembled in the battery assembling step and before the electrolyte 27 is injected in the injection step, but the order is not limited to this. For example, the coating forming step may be performed to the negative electrode sheet 41 after the negative electrode sheet 41 is formed in the negative electrode sheet producing step and before the electrode body 30 is formed in the electrode body forming step. Alternately, the coating forming step may be performed to the electrode body 30 after the electrode body forming step and before the terminal welding step in which the positive terminal 60 and the negative terminal 70 are welded to the electrode body 30. Alternately, the coating forming step may be performed after the terminal welding step and before the battery assembling step to the electrode body 30 which has been welded with the positive terminal 60 and the negative terminal 70.

### REFERENCE SIGNS LIST

10 Lithium ion secondary battery (cell)
27 Electrolyte
30 Electrode body
31 Positive electrode sheet
32 Positive electrode foil
33 Positive active material layer
41 Negative electrode sheet
42 Negative electrode foil (copper foil)
42a Primary face
42aw Layer-formed portion
42am Exposed portion
42c Oxide film under active material
42d Exposed oxide film
43 Negative active material layer (active material layer)
51 Separator
60 Positive electrode terminal (positive terminal member)
70 Negative electrode terminal (negative terminal member, terminal member)

1. A method for producing a battery including: an electrode sheet having a copper foil and an active material layer formed partially on each of front and back primary faces of the copper foil; and an electrolyte,
the copper foil being configured such that:
each of the primary faces includes a layer-formed portion on which the active material layer exists, the layer-formed portion being formed with either no oxide film made of oxidized copper or an oxide film located under the active material and made of oxidized copper with a thickness of 5.0 nm or less; and
each of the primary faces includes an exposed portion where the primary face is exposed, the exposed portion having an exposed oxide film made of oxidized copper with a thickness thicker than the layer-formed portion, and
the battery including a terminal member welded to the exposed portion of the copper foil of the electrode sheet,
wherein the method comprises:
an active material layer forming step of forming the active material layer on the layer-formed portion of each of the entire primary faces of the copper foil having no oxide film made of oxidized copper or having the oxide film made of oxidized copper with the thickness of 5.0 nm or less;
a coating forming step of forming the exposed oxide film in the exposed portion by oxidizing the exposed portion of the copper foil after the active material layer forming step;
an injection step of injecting the electrolyte into the battery after the coating forming step;
an initial charging step of initially charging the battery after the injection step; and
a terminal welding step of welding the terminal member to the exposed portion of the copper foil prior to the coating forming step.

2. The method for producing the battery according to claim 1, wherein the coating forming step includes forming the exposed oxide film having a thickness of 6.0 nm or more.

3. The method for producing the battery according to claim 2, wherein the coating forming step includes forming the exposed oxide film having a thickness of 17.0 nm or less.

4. The method for producing the battery according to claim 1, wherein the coating forming step includes heating at least the exposed portion of the copper foil at a temperature range of 80° C. to 100° C. for 10 to 180 minutes under atmospheric circumstances.

5. (canceled)

6. A battery including: an electrode sheet having a copper foil and an active material layer formed on a part of each of front and back primary faces of the copper foil; and an electrolyte,
wherein the copper foil is configured such that:
each of the primary faces includes a layer-formed portion on which the active material layer exists, the layer-formed portion being formed with either no oxide film made of oxidized copper or having an oxide film located under the active material and made of oxidized copper with a thickness of 5.0 nm or less;
each of the primary faces includes an exposed portion, where the face is exposed, the exposed portion having an exposed oxide film made of oxidized copper with a thickness thicker than the layer-formed portion;
the battery includes a terminal member welded to the exposed portion of the copper foil of the electrode sheet; and
the exposed oxide film is formed after the terminal member has been welded to the copper foil.

7. The battery according to claim 6, wherein the exposed oxide film has a thickness of 6.0 nm or more.

8. The battery according to claim 7, wherein the exposed oxide film has a thickness of 17.0 nm or less.

9. (canceled)
